(19) United States
(12) Patent Application Publication
(10) Pub. No.: US 2002/0170462 A1
(43) Pub. Date: Nov. 21, 2002

(54) Interference-tone water-based lnks for writing instruments

(75) Inventor: Mayumi Terai, Chiba-ken (JP)

Correspondence Address: GREENBLUM & BERNSTEIN, P.L.C., 1941 ROLAND CLARKE PLACE, RESTON, VA, 20191, US

(73) Assignee: Zebra Co., Ltd., Tokyo (JP)

(21) Appl. No.: 09/967,997

(22) Filed: Oct. 2, 2001

(30) Foreign Application Priority Data
Feb. 19, 2001 (JP) 2001-041352

(51) Int. Cl. C09D 11/00

(52) U.S. Cl. 106/31.65; 106/31.28; 106/417; 106/442; 106/31.9

(57) ABSTRACT

Provided is an ink for writing instruments which contains an interference pigment as a colorant and is designed to change the color tone of a line drawn with the ink depending on the darkness of a writing surface. The ink for writing instruments therefore contains an interference pigment coated, on the surface of a flaky minute base material, with a metal oxide having a high refractive index.

### BACKGROUND OF THE INVENTION

1. Field of the Invention

The present invention relates to inks for writing instruments, particularly inks for writing instruments which contain an interference pigment and by making use of its interference action, undergo a markedly characteristic color change; and writing instruments using the ink.

2. Description of the Related Art

As water-based inks with a metallic tone, silver ink compositions using aluminum powder are known. Ink compositions with a metallic tone such as gold obtained by tinting them with a dye or pigment as needed have already been put on the market. Such inks composed of an aqueous dispersion of aluminum powder and, as a colorant, a dye or pigment is however accompanied with the drawback that a lustrous color with a gentle tone is not available only by adjusting the content of aluminum powder.

With a view to overcoming this problem, ink compositions with a metallic or pearl tone obtained by incorporating a pearl pigment in inks are proposed as described in Japanese Patent Application Laid-Open No. 05-117569, more specifically, in sections thereof corresponding to [0006] and [0007]. As described in the section corresponding to [0015], the resulting ink compositions are useful for instruments such as paint markers, brush pens and felt-tip pens, each equipped with an ink penetrable writing wick at the cylinder inlet of the container, but not suited for ballpoint pens because the pigment contained therein precipitates because of insufficient viscosity.

Among various pearl pigments such as natural pearl, basic lead carbonate, bismuth oxychloride, lead hydrogenarsenate and titanium dioxide coated mica, titanium dioxide coated mica is most popular because it is nontoxic and has excellent heat resistance and chemical resistance. A beautiful chromatic pearl color is produced by such inks having a pearl pigment with a silver tone, which is available by multiple light reflection of platelet-shaped crystal particles regularly arranged in parallel, and a water-dispersion type colored spherical resin pigment.

Japanese Patent Application Laid-Open No. 07-118592 which has disclosed a water-based ballpoint pen ink using only a pearl pigment as a coloring agent includes descriptions about a viscosity necessary for a ballpoint pen ink as those in sections corresponding to [Claim 1] and [0009]. In such a wide and therefore ambiguous viscosity range, however, the resulting ballpoint pen does not always exhibit a satisfactory function.

Japanese Patent Application Laid-Open No. 2000-72995 wherein an ink with a metallic tone comprising silicate glass flakes coated with a thin metallic layer such as silver or hastelloy is proposed includes a description as that in a section corresponding to [0005]. No reference is made to a viscosity indispensable for a ballpoint pen and in addition, the glass flakes are coated with a thin metallic film but not with a metal oxide.

None of these three publications include a description on an interference-type ink.

The inks proposed to date are poor in flip-flop of color and inks for writing instruments undergoing a markedly characteristic color change are not known yet.

In addition to the conventional requirements for the inks of a writing instrument such as excellent stability and smooth flow without causing clogging at the tip of a pen, they are required to develop a metallic lustrous color upon writing or undergo a change in a color tone. Writing instruments such as marking pens or ballpoint pens have now a variety of ink colors so that inks having the above-described characteristics are presumed to be interesting for consumers. As inks for causing flip-flop of the color of a written line, decolorable inks after writing and those developing two colors from one color are known. An ink which permits visual observation, at some angles, of two beautiful colors when written on paper of a dark color such as black paper is however not known.

An object of the present invention is therefore to provide an ink for writing instruments which contains an interference pigment, thereby making it possible to cause a change in the color tone of a written line depending on the color shade of a surface to be written.

Another object of the present invention is to provide an ink for writing instruments capable of undergoing a change in the color of a written line depending on the angle of visual observation to thus produce a markedly characteristic written line, maintaining the same color tone even after long-term storage, and producing a stable written line; and a writing instrument using the ink.

### SUMMARY OF THE INVENTION

The above-described objects of the present invention can be attained by adoption of an interference-tone water-based ink for writing instruments which comprises an interference pigment obtained by coating the surface of at least one flaky minute base material selected from a silicate glass and mica with titanium dioxide (TiO₂) to give the thickness of the coating layer within a range of 60 to 160 nm and has an average particle size of 5 to 125 μm.

The above-described interference-tone water-based ink for writing instruments preferably comprises at least one colorant selected from colored spherical resin pigments, pigments and dyes.

More preferably, the above-described interference-tone water-based ink for writing instruments comprises 1 to 35 mass % of the interference pigment and 0.05 to 50 mass % of the colorant.

The above-described interference-tone water-based ink for writing instruments preferably has a viscosity of 2000 to 15000 mPa.s and a non-Newtonian viscosity index of 0.10 to 0.65 at 25° C. under a shear rate of 0.75 s⁻¹, wherein the non-Newtonian viscosity index is “n” in the viscosity equation represented by:

η=kDⁿ⁻¹ (1>n>0)

in which η stands for viscosity (Pa.s) , D stands for a shear rate (s⁻¹) and k stands for a non-Newtonian viscosity coefficient).

The another object of the present invention can be attained by adoption of a writing instrument containing the above-described interference-tone water-based ink for writing instruments.

A natural-pearl-like unique color created by regular multiple reflection of incident light at the boundary of two layers of calcium carbonate and protein stacked in parallel is called “pearl luster” and pigments expressing pearl luster are generally called “pearl pigments”. Examples of the pearl pigments include natural pearl, basic lead carbonate, bismuth oxychloride, lead hydrogenarsenate and titanium dioxide coatedmica. Titanium dioxidecoatedmica is popular because it is nontoxic and has excellent heat resistance and chemical resistance. For pearl luster, a multilayer structure of platelet-like crystals stacked regularly in parallel is inevitable and this structure enables development of pearl luster by causing regular multiple reflection of incident light at the boundary of two layers. When the surface of mica is coated thick with a metal oxide having a high refractive index typified by titanium dioxide, reflection of only a light having a wavelength corresponding to the thickness of the coating layer also occurs at the interface between mica and titanium dioxide, thereby causing interference. In short, the wavelength of light to be interfered changes depending on the thickness of the metal oxide coating layer on the surface, making it possible to change the apparent color. This principle works independently of multiple reflection of incident light due to a multilayer structure of platelet-like crystals, such as mica, regularly stacked in parallel so that a base material is not limited to mica. An interference pigment can be prepared by subjecting a silicate glass or the like to a similar treatment. Even if mica usually producing pearl luster is used as a base material, pearl luster with a silver tone is not developed because of high interfering action at the interface between mica and titanium dioxide. On the contrary, a color with a tone of unexpected brightness is available.

For example, when the surface of a base material is coated with titanium dioxide to give the thickness of a coating layer of 60 to 80 nm, 80 to 100 nm, 100 to 140 nm and 120 to 160 nm, the resulting inks develop characteristically beautiful yellow, red, blue and green colors, respectively, when applied onto black paper. The thickness of the titanium dioxide coating layer permitting exhibition of interfering action is not limited to the above-described ranges. Even if the thickness of the coating layer is less than 60 nm or thicker than 160 nm, interfering action is available when the optical path difference of incident light between the surface of titanium dioxide and the interface between titanium dioxide and the base material is set at one-fourth or three-fourth of the wavelength of light. But, the most beautiful color is developed within the above-described thickness range. The thickness of the coating layer can be measured not only by observation through an electron microscope but also by a film thickness measuring instrument called “ellipsometer”. On white paper, the complementary color of each of them, for example, a green color on white paper if the color is red on black paper, can be observed. In addition, it causes a change in an apparent color depending on the angle of incident light, thus bringing about interference effects. A pigment causing a change in an apparent color depending on the angle of incident light, that is, having interference effects is called “interference pigment”.

An ink having an interference pigment and a colorant in combination produces a unique color, that is the color of the pigment with luster when applied onto white paper, while flip-flop can be observed between two colors, that is, a color on white paper and another color different therefrom depending on the observation angle, when applied onto black paper.

As the metal oxide, lead oxide, indium oxide, chromium oxide and zinc oxide are usable as well as titanium dioxide and iron oxide, but titanium dioxide is preferred from the viewpoints of a refractive index, chemical resistance, weather resistance, heat resistance and safety. The refractive index of titanium dioxide ranges from 2.5 to 2.7, while that of iron oxide is about 2.9.

According to the present invention, it is therefore possible to provide an interference-tone water-based ink or gel ink for marking pens which causes a change in the color of a drawn line depending on the color shade of a writing surface, thus having a considerably characteristic ink color, and is capable of maintaining the same color tone even after long term storage and drawing a stable line; and a writing instrument filled with the ink.

### BRIEF DESCRIPTION OF THE DRAWINGS

The drawings of the present invention will next be described briefly.

FIG. 1 is a longitudinal cross-sectional view illustrating one example of a ballpoint pen for which the interference-tone water-based ink of the present invention has been used.

### PREFERRED EMBODIMENTS OF THE INVENTION

No particular limitation is imposed on the interference pigment insofar as it has interference effects by light. Examples of it include IRIODINs [AFFLAIRs in America] 201, 205, 211, 215, 219, 221, 223, 225, 231, 235, 249, 259, 289 and 299 (each, trade name; product of Merck Japan Ltd.) and METASHINE (trade name; product of NIPPON SHEET GLASS Co., Ltd.).

IRIODINs (100 series) as described in Japanese Patent Application Laid-Open No. 05-117569 are silver-tone pearl pigments in the white powder form and they differ in particle size by a series number. This difference in particle size leads to a difference in visual brightness and texture of pearl. They all have a silver tone so that black paper becomes only whitish by application of this silver tone.

IRIODINs (200 series) as described herein have interference action so that in spite of being in the white powder from, they develop colors such as yellow, red, blue, green and violet when applied to black paper.

Interference pigments having a large particle size do not form a stable dispersion in an ink. They tend to be precipitated or cause clogging of a pen tip such as marker, preventing smooth discharge of the resulting ink from the pen tip. When they have a small particle size, on the other hand, the characteristic color of this invention cannot be developed easily. An interference pigment having a particle size of 5 to 125 μm, preferably 5 to 25 μm is preferably employed.

The colorant usable in the present invention is at least one colorant selected from colored spherical resin pigments, pigments and dyes. No particular limitation is imposed on the kind of the pigment. Examples of inorganic pigments include titanium dioxide, carbon black and metal powders, while those of organic pigments include azo lakes, insoluble azo pigments, chelate azo pigments, phthalocyanine pigments, perylene or perinone pigments, anthraquinone pigments, quinacridone pigments, dye lakes, nitro pigments and nitroso pigments.

As the colored spherical resin pigment, LUMIKOL series pigments [trade name; products of Nippon Keiko Kagaku Co., Ltd.] and SINLOIHI COLOR BASE series pigments (trade name; products of SINLOIHI Co., Ltd.) are usable. As the water soluble dye, any one of direct dyes, acid dyes, food dyes and basic dyes are usable.

As described above, an ink containing both an interference pigment and a colorant produces a color of the colorant with characteristic luster when applied on white paper. When it is applied on black paper, flip-flop of two colors, that is, a color on white paper and another color different therefrom, can be observed, depending on an angle. An ink containing an inorganic pigment or organic pigment has small interference effects, because the inorganic or organic pigment remains on the surface of paper after application and owing to its strong light shading property against an interference pigment, the surface of the interference pigment is coated with the pigment having strongly light shading property. An ink containing, together with an interference pigment, a dye penetrable through the written surface exhibits the maximum interference effects, but it happens to cause transfer to the back side. Use of a colorant having a weak light shading property and not easily causing backside transfer in combination with an interference pigment is therefore presumed to provide an ink exhibiting the maximum interference effects and excellent writing properties without backside transfer. Accordingly, an ink having large interference effects for a line drawn therewith and having excellent writing performance can be obtained by using a colored spherical resin pigment having excellent light transmission and is free from backside transfer in combination with an interference pigment.

The interference-tone water-based ink of the present invention is most suited for use as an ink for water-based ballpoint pens. An increase in the static viscosity is necessary for stably dispersing such colorants in an ink, thereby obtaining an ink for water-based ballpoint pens. As an additive for bringing about thickening effects without disturbing various performances as a ballpoint pen, xanthan gum having shear-rate thinning effects is most preferred. An additive having too low or too high thickening effects is not suited for a water-based ballpoint pen ink, because it causes precipitation of the colorant or it prevents smooth flow of the ink, respectively. An ink containing a thickener having small shear-rate thinning effects is not discharged well or does not provide a smooth writing touch, thus being inferior in performances of writing instruments even if the pigment is dispersed well. A gel ink for water-based ballpoint pens having a viscosity falling within a range of 2000 to 15000 mPa.s (shear rate: 0.75 s⁻¹, 25° C.) is usually appropriate.

The interference-tone water-based ink of the present invention is also usable as an ink for marking pens. The proper viscosity range of an ink for marking pens is usually 1 to 50 mPa.s (shear rate: 75 s⁻¹, 25° C.). If an ink for marking pens has a viscosity exceeding 50 mPa.s, it does not flow smoothly and writing failure such as blurring occurs.

It is also possible to cause a different color change by using a conventionally known colorant such as water soluble dye, organic pigment, inorganic pigment or colored spherical resin pigment as needed. In addition to the above-described components, additives ordinarily employed for a writing ink such as lubricant, rust preventive and mildew proofing agent can be added to the ink composition of the present invention.

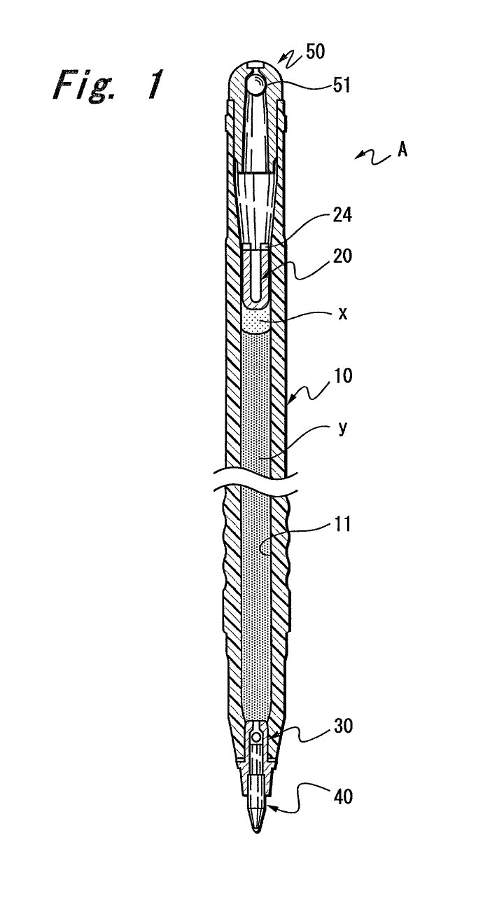

In FIG. 1, illustrated is one example of a water-based ballpoint pen using the interference-tone water-based ink of the present invention. As described above, the ink of the present invention preferably has high shear-rate thinning effects. A ballpoint pen using such an ink is equipped with an ink follower (20) for preventing dispersion of a highly viscous liquid at the end of the ink. Indicated at numeral (30) is a back-flow preventing mechanism for closing an ink passage upon writing upwards, thereby preventing the reverse flow. A breech block (50) is installed at the rear-end opening portion of the ink reservoir (10) in the form of a cylinder shaft and has, in it, an ink outflow preventing mechanism (51) for preventing outflow of the ink to the rear portion. A chip (40) may have a spring equipped at a transfer ball. The ball is pressed against the end portion of a ball holder by the repulsion of the spring to close an ink discharge port, whereby drying of the ink due to contact with outside air can be prevented.

### EXAMPLES

The present invention will hereinafter be described in further detail. It should however be borne in mind that the present invention is not limited by them. In these examples, viscosity was measured at 25° C. by a Brookfield viscometer, Cone No. 40. Its rotation speed was set at 0.1 rpm for a gel ink and 10 rpm for a marking pen ink. The preferred ink viscosity of a ballpoint pen ranges from 5000 to 10000 mPa.s, while that of a marking pen ranges from 5 to 20 mPa.s.

(Example 1)

| | Parts by mass |
|---|---|
| IRIODIN 200 (trade name; | 10.0 |
| product of Merck Japan Ltd.) | |
| Glycerin | 20.0 |
| Deionized water | 50.5 |
| Xanthan gum | 0.5 |

A lubricant, rust preventive, mildew proofing agent and the like were added to the above-described composition and they were stirred for 4 hours in a dissolver, whereby a gel ink for white water-based ballpoint pen having a viscosity of 6150 mPa.s (shear rate: 0.75 s⁻¹, 25° C.) was obtained.

(Example 2)

| | Parts by mass |
|---|---|
| IRIODIN 211 (trade name; | 15.0 |
| product of Merck Japan Ltd.) | |
| LUMIKOL NKW-3608 (trade name; | 10.0 |
| product of Nippon Keiko Kagaku | |
| Co., Ltd.) | |
| Glycerin | 20.0 |
| Deionized water | 50.5 |
| Xanthan gum | 0.7 |

A lubricant, rust preventive, mildew proofing agent and the like were added to the above-described composition and they were stirred for 4 hours in a dissolver, whereby a gel ink for blue water-based ballpoint pen having a viscosity of 12500 mPa.s (shear rate: 0.75 s⁻¹, 25° C.) was obtained.

(Example 3)

| | Parts by mass |
|---|---|
| IRIODIN 221 (trade name; | 10.0 |
| product of Merck Japan Ltd.) | |
| LUMIKOL NKW-2117 (trade name; | 10.0 |
| product of Nippon Keiko Kagaku | |
| Co., Ltd.) | |
| Glycerin | 20.0 |
| Deionized water | 50.5 |
| Xanthan gum | 0.6 |

A lubricant, rust preventive, mildew proofing agent and the like were added to the above-described composition and they were stirred for 4 hours in a dissolver, whereby a gel ink for pink water-based ballpoint pen having a viscosity of 9840 mPa.s (shear rate: 0.75 s⁻¹, 25° C.) was obtained.

(Example 4)

| | Parts by mass |
|---|---|
| IRIODIN 223 (trade name; | 15.0 |
| product of Merck Japan Ltd.) | |
| LUMIKOL NKW-3605 (trade name; | 20.0 |
| product of Nippon Keiko Kagaku | |
| Co., Ltd.) | |
| Glycerin | 20.0 |
| Deionized water | 50.5 |
| Xanthan gum | 0.65 |

A lubricant, rust preventive, mildew proofing agent and the like were added to the above-described composition and they were stirred for 4 hours in a dissolver, whereby a gel ink for yellow ballpoint pen having a viscosity of 13500 mPa.s (shear rate: 0.75 s⁻¹, 25° C.) was obtained.

(Example 5)

| | Parts by mass |
|---|---|
| METASHINE RCFSX-RC (trade name; | 5.0 |
| product of NIPPON SHEET GLASS | |
| Co., Ltd.) | |
| LUMIKOL NKW-2104 (trade name; | 30.0 |
| product of Nippon Keiko Kagaku | |
| Co., Ltd.) | |
| Glycerin | 20.0 |
| Deionized water | 50.5 |
| Xanthan gum | 0.5 |

A lubricant, rust preventive, mildew proofing agent and the like were added to the above-described composition and they were stirred for 4 hours in a dissolver, whereby a gel ink for orange water-based ballpoint pen having a viscosity of 9400 mPa.s (shear rate: 0.75 s⁻¹, 25° C.) was obtained.

(Example 6)

| | Parts by mass |
|---|---|
| IRIODIN 299 (trade name; | 10.0 |
| product of Merck Japan Ltd.) | |
| A 30% aqueous solution of Eosin | 30.0 |
| Glycerin | 20.0 |
| Deionized water | 50.5 |
| Xanthan gum | 0.5 |

A lubricant, rust preventive, mildew proofing agent and the like were added to the above-described composition and they were stirred for 4 hours in a dissolver, whereby a gel ink for red water-based ballpoint pen having a viscosity of 5700 mPa.s (shear rate: 0.75 s⁻¹, 25° C.) was obtained.

(Example 7)

| | Parts by mass |
|---|---|
| IRIODIN 221 (trade name; | 10.0 |
| product of Merck Japan Ltd.) | |
| LUMIKOL NKW-7005 (trade name; | 10.0 |
| product of Nippon Keiko Kagaku | |
| Co., Ltd.) | |
| OLESTAR UD100N (trade name; | 20.0 |
| a resin emulsion produced by | |
| Mitsui Chemicals, Inc.) | |
| DELTOP 100 (trade name; | 0.01 |
| an antiseptic produced by TAKEDA | |
| CHEMICAL INDUSTRIES, LTD.) | |
| Deionized water | 20.0 |

The above-described components were mixed by stirring, whereby an ink for yellow marking pen having a viscosity of 3.5 mPa.s (shear rate: 75 s⁻¹, 25° C.) was obtained.

(Example 8)

| | Parts by mass |
|---|---|
| IRIODIN 231 (trade name; | 15.0 |
| product of Merck Japan Ltd.) | |
| LUMIKOL NKW-7005 (trade name; | 10.0 |
| product of Nippon Keiko Kagaku | |
| Co., Ltd.) | |
| OLESTAR UD100N (trade name; | 20.0 |
| a resin emulsion produced by | |
| Mitsui Chemicals, Inc.) | |
| DELTOP 100 (trade name; | 0.01 |
| an antiseptic produced by TAKEDA | |
| CHEMICAL INDUSTRIES, LTD.) | |
| Deionized water | 20.0 |
| Xanthan gum | 0.2 |

The above-described components were mixed by stirring, whereby an ink for red marking pen having a viscosity of 46 mPa.s (shear rate: 75 s⁻¹, 25° C.) was obtained.

### (Comparative Example 1)

In a similar manner to Example 1 except for the use of IRIODIN 121 (silver pearl pigment) instead of IRIODIN 201 (interference pigment), whereby a gel ink for aqueous ballpoint pen having a viscosity of 6500 mPa.s (shear rate: 0.75 s⁻¹, 25° C.) was obtained. A conventionally known and ordinarily employed pearl pigment used in this Comparative Example 1 does not produce a characteristic color which is otherwise available by the interference action of the present invention.

### (Comparative Example 2)

In a similar manner to Example 2 except for an increase in the amount of xanthan gum to 1.1 parts by mass and a proportional decrease in the amount of water, whereby a gel ink for blue water-based ballpoint pen having a viscosity of 18500 mPa.s (shear rate: 0.75 s⁻¹, 25° C.) was obtained.

### (Comparative Example 3)

In a similar manner to Example 3 except for a decrease in the amount of xanthan gum to 0.2 part by mass and an increase in the amount of water by 0.4 part by mass, whereby a gel ink for pink water-based ballpoint pen having a viscosity of 1800 mPa.s (shear rate: 0.75 s⁻¹, 25° C.) was obtained.

### (Test Method)

The inks for water-based ballpoint pen, out of the inks obtained in Examples 1 to 8 and Comparative Examples 1 to 3, were each filled in a polypropylene tube, followed by fitting of a pen tip thereinto. A sufficient amount of the follower was injected from the tail portion, followed by centrifugation at 1960 m.s⁻¹ (200G), whereby a ballpoint pen was produced. The inks for marking pens, on the other hand, were each filled in an ink tank in a similar manner to that of a direct liquid feed type marking pen [CRAFTSTAR, trade name; product of ZEBRA CO., Ltd.], followed by mounting of a tip cover equipped with a valve and then fitting of a polyester pen tip and a cap, whereby a marking pen was produced. A writing test of the marking pens was conducted just after sufficient stirring and sufficient discharging of the ink.

The results of the test on external color of the ink filled in an ink reservoir, colors of lines drawn on black paper and white paper and writing performance are shown in

TABLE 1

| | External color | | | | |
|---|---|---|---|---|---|
| | of an ink filled | | | Writing performance | |
| | in an ink | Color of lines drawn on | | Just after | After passage |
| | reservoir | Black paper | White paper | writing | of time |
| Ex. 1 | White | Gold | White | A | A |
| Ex. 2 | Blue | Reddish violet | Blue | A | B |
| Ex. 3 | Pink | Blue | Pink | A | A |
| Ex. 4 | Yellow | Violet | Yellow | A | B |
| Ex. 5 | Orange | Green | Orange | A | A |
| Ex. 6 | Red | Green | Red | A | A |
| Ex. 7 | Yellow | Blue | Yellow | A | A |
| Ex. 8 | Yellow | Green | Yellow | A | A |
| Comp. Ex. 1 | White | White | White | A | A |
| Comp. Ex. 2 | Blue | Reddish violet | Blue | C | D |
| Comp. Ex. 3 | Pink | Blue | Pink | A | D |

Conditions for passage of time: left to stand in an oven of 50° C. for 1 month

### Evaluation:

Writing performance

A: permits good writing

B: permits writing without problems

C: causes skip

D: does not permit writing

Writing paper

Black paper: Woodfree, thin and black paper

White paper: Woodfree paper (Writing Paper A conformable to JIS P 3201)

The ink of Comparative Example 1 uses an ordinary pearl pigment. The ordinary pearl pigment differs from the pigment of Example 1 in that only white color, that is, the color of the pigment itself can be seen even written on black paper. The ink of Comparative Example 2 can maintain stable dispersion of the pigment because of a markedly high viscosity, but since a discharge amount of the ink is low and a line drawn therewith is therefore not even, a writing instrument using this ink is inferior in the performance. The ink of Comparative Example 3 has a markedly low viscosity so that a sufficient amount of the ink is discharged and a line drawn therewith is clear. Owing to unstable dispersion of the pigment and the like, however, precipitation of the pigment occurs after the passage of time and it disturbs writing. The lines drawn with the inks obtained in Examples 1 to 8 are very interesting because the color of the lines drawn on white paper is different from that on black paper. In addition, owing to these inks, a pen exhibits excellent writing performance even after the passage of time. Thus, the advantages of the present invention have been proved.

What is claimed is:

1. An interference-tone water-based ink for writing instruments, which comprises an interference pigment obtained by coating the surface of at least one flaky minute base material selected from a silicate glass and mica with titanium dioxide (TiO₂) to give the thickness of the coating layer falling within a range of 60 to 160 nm and having an average particle size of 5 to 125 μm.

2. An interference-tone water-based ink for writing instruments according to claim 1, further comprising at least one colorant selected from colored spherical resin pigments, pigments and dyes.

3. An interference-tone water-based ink for writing instruments according to claim 2, comprising 1 to 35 mass % of the interference pigment and 0.05 to 50 mass % of the colorant.

4. An interference-tone water-based ink for writing instruments according to claim 1, having a viscosity of 2000 to 15000 mPa.s and a non-Newtonian viscosity index of 0.10 to 0.65 at 25 ° C. under a shear rate of 0.75 s⁻¹, the non-Newtonian viscosity index being “n” in the viscosity equation represented by:
η=kDnⁿ⁻¹ (1>n>0)
in which η stands for viscosity (Pa.s), D stands for a shear rate (s⁻¹) and k stands for a non-Newtonian viscosity coefficient.

5. An interference-tone water-based ink for writing instruments according to claim 2, having a viscosity of 2000 to 15000 mPa.s and a non-Newtonian viscosity index of 0.10 to 0.65 at 25° C. under a shear rate of 0.75 s⁻¹, the non-Newtonian viscosity index being “n” in the viscosity equation represented by:
η=kDⁿ⁻¹ (1>n>0)
in which η stands for viscosity (Pa.s), D stands for a shear rate (s⁻¹) and k stands for a non-Newtonian viscosity coefficient.

6. An interference-tone water-based ink for writing instruments according to claim 3, having a viscosity of 2000 to 15000 mPa.s and a non-Newtonian viscosity index of 0.10 to 0.65 at 25° C. under a shear rate of 0.75 s⁻¹, the non-Newtonian viscosity index being “in” in the viscosity equation represented by:
η=kD-ⁿ⁻¹ (1>n>0)
in which η stands for viscosity (Pa.s) , D stands for a shear rate (s-⁻¹) and k stands for a non-Newtonian viscosity coefficient.

7. A writing instrument comprising an interference-tone water-based ink which contains an interference pigment obtained by coating the surface of at least one flaky minute base material selected from a silicate glass and mica with titanium dioxide (TiO₂) to give the thickness of the coating layer falling within a range of 60 to 160 nm and has an average particle size of 5 to 125 μm.

8. A writing instrument according to claim 7, wherein the interference-tone water-based ink further contains at least one colorant selected from colored spherical resin pigments, pigments and dyes.

9. A writing instrument according to claim 8, wherein the interference-tone water-based ink contains 1 to 35 mass % of the interference pigment and 0.05 to 50 mass % of the colorant.

10. A writing instrument according to claim 7, wherein the interference-tone water-based ink has a viscosity of 2000 to 15000 mPa.s and a non-Newtonian viscosity index of 0.10 to 0.65 at temperature of 25° C. and shear rate of 0.75 s⁻¹, the non-Newtonian viscosity index representing n in the viscosity equation represented by:
η=kDⁿ⁻¹ (1>n>0)
in which η stands for viscosity (Pa.s) , D stands for a shear rate (s⁻¹) and k stands for a non-Newtonian viscosity coefficient).

11. A writing instrument according to claim 8, wherein the interference-tone water-based pigment has a viscosity of 2000 to 15000 mPa.s and a non-Newtonian viscosity index of 0.10 to 0.65 at 25° C. under a shear rate of 0.75 s⁻¹, the non-Newtonian viscosity index being “n” in the viscosity equation represented by:
η=kDⁿ⁻¹ (1>n>0)
in which η stands for viscosity (Pa.s), D stands for a shear rate (s⁻¹) and k stands for a non-Newtonian viscosity coefficient.

12. A writing instrument according to claim 9, wherein the interference-tone water-based ink has a viscosity of 2000 to 15000 mPa.s and a non-Newtonian viscosity index of 0.10 to 0.65 at 25° C. under a shear rate of 0.75 s⁻¹, the non-Newtonian viscosity index being “n” in the viscosity equation represented by:
η=kDⁿ⁻¹ (1>n>0)
in which η stands for viscosity (Pa.s) , D stands for a shear rate (s⁻¹and k stands for a non-Newtonian viscosity coefficient.
